(19) United States
(12) Patent Application Publication
(10) Pub. No.: US 2019/0322039 A1
(43) Pub. Date: Oct. 24, 2019

(54) ADDITIVE PRODUCTION OF A THREE-DIMENSIONAL COMPONENT COMPRISING AN ENVELOPING ELEMENT AND A FILLER MATERIAL

(71) Applicant: HOMAG Bohrsysteme GmbH, Herzebrock-Clarholz (DE)

(72) Inventors: Dennis BURSCH, Bornheim (DE); Thomas BETTERMANN, Bielefeld (DE)

(21) Appl. No.: 16/461,783

(22) PCT Filed: Nov. 16, 2017
(86) PCT No.: PCT/EP2017/079436

§ 371 Date: May 16, 2019

(30) Foreign Application Priority Data
Nov. 17, 2016 (DE) 10 2016 122 131.7

(51) Int. Cl. B29C 64/188; B33Y 10/00; B33Y 30/00; B29C 64/118; B29C 64/209; B33Y 70/00

(52) U.S. Cl. CPC B29C 64/188; B33Y 10/00; B33Y 30/00; B29K 2105/16; B29C 64/209; B33Y 70/00; B29C 64/118

(57) ABSTRACT

The invention relates to a method for the production of a component, comprising the steps of: creating at least one portion of an enveloping element (10) of the component by means of an additive method, and introducing a filler material (20), which is in particular foamable or at least partially foamed, into the portion of the enveloping element (10).

### TECHNICAL FIELD

The present invention relates to a method for the production of a component/workpiece, wherein the component is produced at least in part using an additive method. In particular, such a method can be used in the field of component production for the furniture and structural component industry. In addition, the invention relates to both a device and product.

### PRIOR ART

The document DE 2014 206 697 A1, for example, which relates to a device and a method for creating volumetric bodies, is well known in the field of the additive method. The device shown in this document comprises a machining tool for preferably erosive machining of workpieces, a feeding device for feeding an additive material such as, in some cases, a wood material such as wood foam, and an application unit for forming volumetric bodies from the material fed by means of the feeding device.

Furthermore, it is known as part of an additive method to manufacture workpieces using the fused filament fabrication method (also known as fused deposition modelling (FDM) method), wherein a component is built up from a thermoplastic layer by layer. This method consists in melting a plastic granulate or plastic filament, pressing it through a nozzle and depositing it in layers.

When producing components in the fused filament fabrication method, what are known as filler or supporting structures are created to increase the stability of the component and to support overhangs. These structures are created within or outside of an outer contour of the component. Filler structures remain inside the component, whereas supporting structures are usually separate from the component.

Due to the design selected for this filler structure and its scaling, the density of the printed component can be varied, and a higher strength can be achieved for the component. The design of course also affects the strength of the component. In the case of a supporting structure, the choice of design ensures relatively quick manufacture or increased strength of the supporting structure, depending on the application scenario.

Depending on the model of the 3D printer used, the filler or supporting structures are created with the same printing device as the outer contour or with a separate printing device. In the case of a system with two printing heads, filler structures can also be manufactured from a different thermoplastic than that used for the outer contour.

However, the procedure described does present several disadvantages. In particular, a relatively long time is required to produce components when creating a filler structure, as each strip of the filler structure has to be printed separately. This particularly applies if higher strength requirements are made on the component with said filler structure. This normally requires greater use of material and therefore a longer production time. The situation is similar when creating supporting structures using the production method described above.

In addition, the known procedure generates a considerably higher energy requirement, and with components of large volume the filler structures form a considerable portion of the total weight of the components. Furthermore, component density can only be influenced to a very limited extent when using filler structures. As the connection between the filler structure and outer enveloping is only partial, only limited strength is achieved in the models, which means that the strength of the components depends greatly on the filler design selected.

### SUBJECT MATTER OF THE INVENTION

The object of the present invention is to provide a method with which the disadvantages known from the prior art are at least partially rectified or reduced, and/or to provide a method that combines flexible production with high throughput. A device and a product are also obtained in order to achieve said objects.

The subject matter of claim 1 provides such a method. Further preferred embodiments are cited in the dependent claims. Furthermore, the present invention relates to a device and a product.

An idea underlying the present invention is to first create a portion of an enveloping element using an additive method, preferably a fused filament fabrication method. The portion of the enveloping element can then, particularly once it has largely or fully hardened, be filled with a filler material, in particular a filler material that is foamable or at least partially foamed. This means, for example, that components of relatively large volume, possibly with a complex outer contour, can be produced quickly. The invention therefore allows the variability of an additive method with relatively easy production.

The method according to claim 1 comprises the steps of: creating at least one portion of an enveloping element by means of an additive method, and introducing a filler material, in particular a foam material, into the portion of the enveloping element, in particular a filler material that is foamable or is at least partially foamed. It is preferred that said steps are carried out in the order specified.

A component can thus be created. The term “component” in this context means any type of body to be created. The term “component” is in particular synonymous with a “workpiece”, “structural component” or similar. Specific examples of components, workpieces or structural components include pieces of furniture, floor panels, wall panels, kitchen worktops, etc.

What is known as a foam material is preferably used as a filler material. A “foam material” in the context of the invention means a material that can either be foamed or is already present in a foamed or partially foamed state. During foaming, pores or air pockets are created in the filler material, thereby creating a porous or foam-like structure.

The portion of the enveloping element comprises at least one opening for introducing the filler material. The enveloping element may comprise a floor section and one or more side wall sections, for example.

The introduced filler material preferably fills the portion of the enveloping element at least partially or fully. It is also possible to introduce so much filler material that it partially emerges from the opening of the enveloping element.

The opening in the portion of the enveloping element for introducing the filler material can then be closed, and/or a further portion of the enveloping element, preferably to be filled with filler material, is created.

By using a filler material, in particular a foam material, it is possible in the present case to considerably shorten the printing time for the additive method, in particular the fused filament fabrication method, for producing components. Furthermore, the weight of the component and the energy consumption for producing the component can be reduced.

The comparatively easy adjustability of the properties of the filler material considerably improves the choice of component density. The method described here allows the manufacture of large-volume or alternatively extremely small components with high-strength properties, as the filler material can be fully connected to the outer surface of the component, unlike the filler structures previously known.

The printing time can therefore be significantly reduced with the method of the invention. In addition, it is possible to create component fillings to meet specific requirements within a relatively short period of time by adjusting the properties of the filler material.

Due to the use of the filler material, the printing period is no longer dependent on the component density or filler design. A certain filler design is no longer required if the filler material expands within the filler element and therefore fully fills the space to be filled. There is therefore a correlation between the component density and the porosity and material properties of the filler material, which means that the application time is not affected.

Furthermore, it is possible to reduce energy costs, as the filler material does not have to be melted. The filler material also forms a relatively small portion of the total weight of the component.

Based on knowledge of the chemical composition of the specific filler material used, the component density can be adjusted extremely precisely. In addition, in the case of a foam material, the component density also depends on the degree of foaming and the porosity of the foam, which can also be influenced. It is also possible, using the filler material to fill an enveloping element, to achieve higher strengths than can be attained with conventional filler structures, as the filler material connects over the entire surface to the enveloping element.

In accordance with a preferred embodiment, the additive method is a fused filament fabrication method. This method enables, for example, a thermoplastic to be applied layer by layer to form the enveloping element, which forms an envelope for the filler material subsequently to be introduced.

The filler material is preferably a polyurethane filler material, in particular a 2-component polyurethane filler material. This can expand after or during introduction into the enveloping element, for example, and thus fill the enveloping element.

In addition, the filler material can be a wood foam, aluminium foam or plastic foam.

In a further method step, an exposed area of the filler material can be machined with an erosive method after introduction of the filler material to achieve an even surface. This further surface can be printed, or another material can be applied to the surface.

In accordance with an embodiment, foaming of the filler material takes place prior to introduction, during introduction or after introduction of the filler material, in particular by adding a blowing gas such as nitrogen or carbon dioxide, or by mixing in a foaming agent. This may speed up the process of filling the enveloping element. Furthermore, it is also possible to alter the pore size of the filler material by changing the type and/or volume of blowing gas.

If the filler material is foamed prior to introduction, it will enter the enveloping element in this foamed state. If foaming takes place during introduction, the filler material is present in an at least partially foamed state, wherein the filler material will, where applicable, foam or be made to foam further inside the enveloping element. Foaming after introduction of the filler material means that the filler material is introduced into the enveloping element in a liquid or paste-like state and foams up or is made to foam inside the enveloping element.

In particular, a blowing gas changes from a solid/liquid state to a gaseous state as the temperature changes.

Said blowing gas can, for example, be added in a cryogenic form, i.e. as a cryogen, such as in the form of liquid nitrogen or dry ice (frozen carbon dioxide).

If, for example, more blowing gas is added, larger pores will immediately be obtained, and vice versa. Handling is therefore relatively easy. Furthermore, the relationship between action and reaction can easily be adjusted.

If a foaming agent is used, this can trigger the foaming effect dependent on the temperature, for example. This can be achieved by a heating element on the nozzle of the foam discharging device, for example.

Furthermore, it is possible that the filler material is mixed from two components, wherein the two components have a foaming effect for foaming the applied material, and the foaming effect is dependent on the ratio of the two components.

The foaming effect develops as a result of the reaction of the two components with each other, for example. It is possible that a reaction product of said reaction induces a foaming process in the applied material. For example, a gas such as carbon dioxide can be released to achieve the foaming effect.

The use of a 2-component foam offers the advantage that the foaming is easy to control, and the pore size can thus be adjusted.

According to another embodiment, the enveloping element can be provided and/or printed with a coating or decorative element (such as a real wood veneer, plastic strip, etc.).

Furthermore, the present invention relates to a device for the production of a component, comprising: a first device, in particular a printing device, to create at least one portion of an enveloping element by means of an additive method, a second device, in particular a foam discharging device, wherein the second device is set up to discharge a foamable or at least partially foamed filler material and introduce it into the portion of the enveloping element.

The manufacture of a component can be speeded up considerably through the combination of a first device for the production of an enveloping element and a second device for filling said enveloping element. Furthermore, components can be created as required. Reference is made to the description above as regards further advantages.

It is preferred that the first device, in particular a printing device, and the second device, a foam discharging device, are attached to a carrier, particularly a cantilever or portal, in particular are attached to a carriage that can move along the carrier. A compact design can thus be realized.

In accordance with an embodiment, the first device comprises an extruder that is set up to heat and discharge a granulate or filament-like material. The enveloping element can thus be created in a fused filament fabrication method.

The device can also comprise a machining unit for chip-generating machining, in particular a milling unit, a drilling unit or a grinding unit. Furthermore, it is preferred that the machining unit is attached together with the first device (printing device) and/or the second device (foam discharging device) to a carrier, particularly a cantilever or portal, and even more preferably to a carriage that is movable along the carrier.

Furthermore, it is preferred that the device is set up to carry out a method according to one of the above aspects. Conversely, the method is intended according to other variants to work using a device according to one of the aforementioned aspects.

The present invention also relates to a component, in particular a piece of furniture such as a kitchen worktop, the front panel of a piece of furniture or a leaf, flooring element, counter or similar, comprising: at least one enveloping element made from a first material, which forms at least one portion of an outer surface of the product, and a filler material which is arranged within and fills the at least one enveloping element, wherein the at least one enveloping element is produced by means of an additive method, in particular a fused filament fabrication method.

In accordance with another objective of the present invention, it is also possible to use an enveloping element manufactured from a solid body in an erosive machining method. This alternative method can include the following steps:

A method for the production of a component comprising the steps of: providing at least one portion of an enveloping element of the component by using an erosive machining method, in particular milling, and introducing a filler material into the portion of the enveloping element.

This method can also be combined with one of the dependent claims and/or one of the previously discussed embodiments.

In accordance with the further objective, a component is also provided featuring the following: at least one enveloping element, which forms at least one portion of an outer surface of the product, and a filler material, which is placed inside and fills the at least one enveloping element, wherein another material, in particular a plastic material, is introduced into a recess in the filler material, in particular to form a bearing.

### BRIEF DESCRIPTION OF THE FIGURES

FIG. 1 shows a first embodiment of the sequence of a method according to the invention

FIG. 2 shows a second embodiment of the sequence of a method according to the invention

### DETAILED DESCRIPTION OF THE PREFERRED EMBODIMENT

Exemplary sequences of a method according to the invention are described below based on the enclosed figures. Other modifications of certain steps of the method cited in this context can each also be combined individually to create new embodiments.

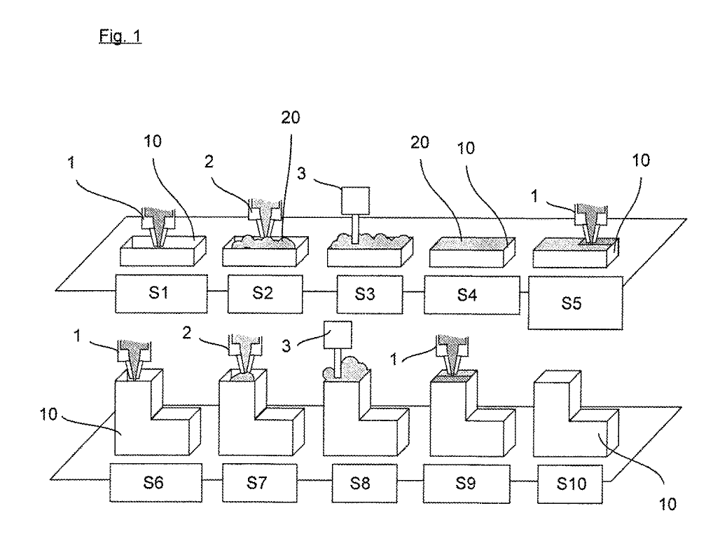

FIG. 1 shows a first embodiment of the sequence of a method according to the invention.

First of all, as part of the method, an enveloping element 10 is created (printed) using a fused filament fabrication method in a first method step S1. To this end, the corresponding material, in particular a thermoplastic material, is melted in an extruder and pressed through a nozzle of printing device 1.

Once the enveloping element 10 has been produced with a side open upwards in a vertical direction in method step S1, a foam material 20 by way of an exemplary filler material is introduced into the enveloping element 10 in a subsequent method step S2 using a foam discharging device 2 (foam nozzle). The enveloping element 10 is essentially completely filled.

The aforementioned foam material 20 may be, for example, a reactive foam such as a PU foam, which is, so to speak, injected into the enveloping element 10 and expands therein. As the foam material 20 hardens, it also connects to the inside of the enveloping element 10.

In a subsequent method step S3, the foam material 20 that is present in the area of the open side of the enveloping element 10 and is uneven or protruding is removed. In this context, a milling unit 3 is used to remove the protruding foam material 20 by milling, and an even surface of the foam material 20 is thus achieved. The milling unit 3 can be a 3-axis milling unit, a 4-axis milling unit or a 5-axis milling unit.

On completion of milling, there is an intermediate product in method step S4, wherein the side areas and the underside of the intermediate product are formed by the enveloping element 10 and the top side of the intermediate product is largely formed by the smoothed and milled foam material 20. Method step S4 may comprise the cleaning of the intermediate product.

In a further method step S5, a portion of the milled foam material is now printed with the fused filament fabrication method using the printing device 1. In the present exemplary embodiment, an even surface is created section by section as part of the enveloping element 10.

In addition, another outer contour is printed in a method step S6, thereby in effect expanding the enveloping element 10. The outer contour created in the method step defines a cavity. Once the outer area of the expanded enveloping element 10 has been created, the resulting cavity is filled with foam (method step S7). The opening area of the expanded enveloping element 10 is also milled and any protruding parts of the foam material are removed as part of this process (method step S8).

The portion of foam material still exposed is subsequently printed with the printing device as part of the method of the invention and the enveloping element is thus closed (method steps S9, S10). Cleaning can take place after method step 8.

As part of the embodiment described here, a production method for creating a relatively simple component has been described. It is clear that complex components can also be manufactured using the procedure described. In particular, it is possible to repeat the method steps as many times as required to expand the component. This particularly applies to method steps S6 to S8.

In the method described, the component density can be controlled based on the foaming behaviour and porosity of the foam material 20 used. Depending on the foam system used, the porosity can be adjusted with a high degree of precision. This particularly applies to 2-component PU foams, based on the mixing ratio of the two components, for example.

The present method can be used, for example, to create pieces of furniture, such as kitchen worktops, table tops, front panels of furniture, leaves, floorings, or similar. In particular, the method is suitable for components of large volume.

Furthermore, it is also possible to supplement the components manufactured in this way with simply structured components, for example by connecting other elements using an adhesive method. Purely as an example, a component manufactured according to the method shown in FIG. 1 above could be produced on a plate-shaped workpiece to provide a cost-effective method for manufacturing complex components.

Although the foam material is introduced into the enveloping element 10 vertically from above as part of the method described with reference to FIG. 1, it is also possible to introduce the foam material into the enveloping element through an opening on the side.

Furthermore, it is possible to also print a filler structure within the enveloping element 10 if, for example, higher strength requirements are set, or if the enveloping element 10 is designed with relatively thin walls.

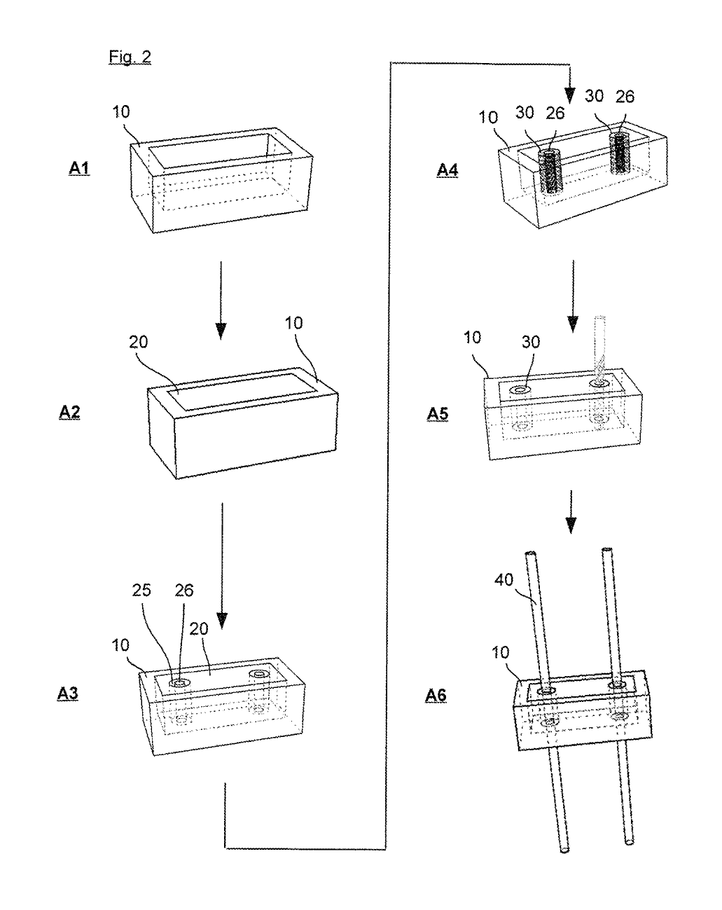

Another embodiment of the present invention is described below in connection with FIG. 2.

First of all, a portion of an enveloping element 10 is produced in a first method step A1. Method step A1 could correspond to method step S1 according to FIG. 1.

The foam material 20 is subsequently introduced into the enveloping element 10 in a method step (not shown in FIG. 2) and an even surface is created using a milling tool. The enveloping element 10 with the foam material 20 is now present in the form shown in method step A2.

A ring-shaped portion 25 is now removed from the area of the foam material 20 using an erosive machining method. A drill or milling tool particularly suited to the task is used for this, for example. A pin-like body 26 made from the foam material 20 (method step A3) remains in the centre of the ring-shaped portion 25.

Subsequently, the ring-shaped portion 25 is filled with a plastic material 30 (method step A4). This plastic material 30 may be introduced into the ring-shaped portion 25 in a liquid or paste-like form, for example.

In a further method step A5, the pin-like body 26 is now removed from the foam material 20 using a drill/milling cutter. The plastic material 30 thus forms a body through which a pin 40 can be inserted in a further method step A6.

The pin 40 should only be regarded as an example here. A shaft could alternatively also be inserted into the plastic body 30. A plastic material with the properties of a friction bearing can be used here.

In addition, a ring-shaped portion 25 that is filled by the plastic material 30 is shown in the embodiment described here. The ring-shaped portion 25 could also be designed as an angular portion, oval portion etc., with or without a centre opening.

The alternatives cited above can also be implemented as part of the second embodiment. For example, the design of the enveloping element 10 can be as complex as required once the enveloping element 10 has been manufactured using an additive method.

Even if a foam material that is foamed before, during or after introduction into the portion of the enveloping element 10 is described as a filler material as part of the present embodiment, other filler materials are also conceivable within the context of the invention.

1. A method for the production of a component, comprising the steps of:
creating at least one portion of an enveloping element of the component by an additive method; and
introducing a filler material into the portion of the enveloping element.

2. The method according to claim 1, wherein the additive method comprises a fused filament fabrication method using a thermoplastic material.

3. The method according to claim 1, wherein the filler material is wood foam, aluminium foam, plastic foam or a polyurethane foam material.

4. The method according to claim 1, wherein such a quantity of filler material is introduced into the portion of the enveloping element that the filler material emerges from the portion of the enveloping element.

5. The method according to claim 1, further comprising the step of:
creating at least one layer on the filler material using an additive method for covering the filler material at least in sections.

6. The method according to claim 1, further comprising the step of:
creating at least one further portion of the enveloping element by an additive method.

7. The method according to claim 1, wherein foaming of the filler material takes place prior to, during or after introduction of the filler material.

8. The method according to claim 1, wherein the steps of creating at least one portion of the enveloping element and introducing a filler material in the portion of the enveloping element are repeated several times.

9. The method according to claim 1, wherein the enveloping element is provided and/or printed with a coating or decorative element.

10. The method according to claim 1, wherein a supporting structure is created with the at least one portion or the at least one further portion of the enveloping element to support the component to be created.

11. The method according to claim 1, wherein a recess is made in the filler material introduced into the portion of the enveloping element using an erosive machining method.

12. The method according to claim 11, wherein a pourable or paste-like material is introduced into the recess.

13. A device for the production of a component, comprising:
a first device for creating at least one portion of an enveloping element of the component by an additive method; and
a second device for introducing a filler material into the portion of the enveloping element.

14. The device according to claim 13, wherein the first device and the second device are attached to a carrier.

15. The device according to claim 13, wherein the first device comprises an extruder that is set up to heat and discharge a filament-like material.

16. The device according to claim 13, wherein, the device also comprises a machining unit.

17. A component comprising:
at least one enveloping element that forms at least a portion of an outer surface of the product, and a filler material, the at least one enveloping element being manufactured by an additive method.

18. The method according to claim 1, wherein the filler material is foamable or at least partially foamed.

19. The method according to claim 3, wherein the polyurethane foam material is a 2-component polyurethane foam material.

20. The method according to claim 4, wherein after introduction of the filler material, an exposed area of the filler material is machined with an erosive, chip-generating, method, to produce an even surface.

21. The method according to claim 5, wherein the additive method for creating the at least one layer on the filler material comprises a fused filament fabrication method.

22. The method according to claim 6, wherein the additive method for creating the at least one further portion comprises a fused filament fabrication method, and wherein the at least one further portion of the enveloping element is subsequently filled with a filler material.

23. The method according to claim 7, wherein foaming of the filler material comprises adding a blowing gas such as nitrogen or carbon dioxide or by mixing in a foaming agent.

24. The method according to claim 11, wherein the erosive machining method corresponds to using a drill or a milling cutter.

25. The method according to claim 12, wherein the pourable or paste-like material is a plastic material.

26. The device according to claim 13, wherein the first device is a printing device.

27. The device according to claim 13, wherein the filler material is a foamable or at least partially foamed filler material.

28. The device according to claim 14, wherein the carrier is a cantilever, portal or articulated arm robot, and wherein the first device and the second device are attached to a carriage that is movable along the carrier.

29. The device according to claim 15, wherein the filament-like material is a thermoplastic material.

30. The device according to claim 16, wherein the erosive machining is chip-generating machining, and wherein the machining unit is a milling unit, drilling unit or grinding unit.

31. The device according to claim 30, wherein the machining unit is attached together with the first device and/or the second device to a carrier, wherein the carrier is a cantilever, portal or articulated arm robot, and wherein the machining unit is attached together with the first device and/or the second device to a carriage that is movable along the carrier.

32. The component according to claim 17, wherein the component is a piece of furniture, the piece of furniture being a kitchen worktop, a front panel of a piece of furniture, a leaf, a flooring element or a counter.

33. The component according to claim 17, wherein the filler material is arranged within and fills at least one enveloping element, and wherein the additive method is a fused filament fabrication method.
